(19) United States
(12) Patent Application Publication
(10) Pub. No.: US 2005/0016928 A1
(43) Pub. Date: Jan. 27, 2005

(54) Apparatus and method for water treatment by a direct co-precipitation/filtration process

(75) Inventors: Xiaoguang Meng, Highland Park, NJ (US); George P. Korfiatis, Basking Ridge, NJ (US)

Correspondence Address: Ralph W. Selitto, Jr., Esq.;McCarter & English, LLP, Four Gateway Center, 100 Mulberry Street, Newark, NJ, 07102, US

(73) Assignee: Trustees of Stevens Institute of Technology

(21) Appl. No.: 10/803,170

(22) Filed: Mar. 17, 2004

Related U.S. Application Data
(63) Continuation-in-part of application No. 10/049,107, filed on Jul. 1, 2002.
(60) Provisional application No. 60/147,708, filed on Aug. 6, 1999.

(51) Int. Cl. C02F 1/52

(52) U.S. Cl. 210/722; 210/202; 210/263

(57) ABSTRACT

Dissolved inorganic contaminants are removed from a dilute aqueous stream by adding a hydrolysable metal compound to the aqueous stream, co-precipitating a hydrolyzed metal compound with the inorganic contaminants, and, concurrently with the co-precipitation step, filtering the co-precipitate from the dilute aqueous stream using a packed bed filter. The process may be carried out so that the metal oxide co-precipitate forms within the packed bed. Dissolved contaminants, particularly arsenic compounds, are removed more efficiently than by conventional co-precipitation/filtration processes. An apparatus for carrying out the process provides for injection of the hydrolysable metal compound into the dilute aqueous stream immediately upstream of the packed bed filter, without an intervening flocculation or sedimentation vessel, thereby providing an effective contaminant removal system that requires a smaller footprint and lower capital cost than conventional water treatment systems.

### CROSS-REFERENCE TO RELATED APPLICATIONS

This application is a continuation-in-part of U.S. patent application Ser. No. 10/049,107, filed on Jul. 1, 2002, which is a national stage application under 35 U.S.C. § 371 of International Application No. PCT/US00/17693, filed on Jun. 28, 2000, which claims the benefit of U.S. Provisional Patent Application No. 60/147,708, filed on Aug. 6, 1999.

### FIELD OF INVENTION

The present invention relates to apparatus and methods for removing dissolved contaminants from aqueous streams. More particularly, the present invention relates to methods of removing dissolved inorganic contaminants from aqueous streams by co-precipitation and filtration of metal oxides.

### BACKGROUND OF INVENTION

Wastewater and natural waters (e.g., surface water or groundwater) may contain a variety of dissolved inorganic substances from natural and anthropogenic sources. Regulatory limits have been set for a number of these substances in drinking water and for discharges to natural waters, for protection of public health and environmental quality. The regulatory limits for many of these substances are set at very low levels, e.g., in the range of 2-50 parts-per-billion (“ppb”) or the equivalent units of measure of micrograms-per-liter (“μg/L”).

Conventional water treatment processes, such as co-precipitation with iron or aluminum salts, lime softening, or filtration using adsorbents or ion exchange resins, are ineffective in removing some of these regulated substances to the mandated levels. This problem is of particular concern with respect to certain types of substances including oxyanions, particularly arsenate and arsenite, and some metals, such as mercury, because of their chemistry in water and the particularly low regulatory limits that have been set for them. For example, in the U.S., the permissible concentration of arsenic in drinking water is limited by the U.S. Environmental Protection Agency to a maximum of 10 μg/L. Individual states within the U.S. are considering maximum concentration limits for arsenic as low as 3 μg/L.

Typically, the removal of such contaminants can be improved by selecting a treatment process that exhibits a greater capacity to sequester or retain the dissolved substance of concern, or provides more favorable kinetics for the removal of that substance (i.e., the treatment reaction proceeds more quickly). The low capacity or unfavorable kinetics of a treatment process can be accommodated to some extent by construction of larger treatment systems to provide longer times for the removal process. The costs of building and operating such a system increases with the size of the system and often causes such an accommodation to become uneconomical. The relatively large vessels required to provide the longer detention times needed for coagulation and sedimentation processes, in particular, contribute substantially to the cost of constructing the system and the area required for its implementation.

Conventional treatment processes for removal of organic compounds and heavy metals from dilute aqueous streams typically are based on chemical precipitation and coagulation followed by conventional sand filtration (Dupont, A. 1986. Lime Treatment of Liquid Waste Containing Heavy Metals, Radionuclides and Organics, 7^{th} edition, Washington D.C., pp. 306-312; Eary, L. E. and D. Rai. 1988. Environ. Sci. Techno. 22:972-977; Chen, R. C. et al. 1994. J. AWWA 86:79-90). Sand filtration alone is not effective in removing heavy metals, especially arsenic and chromate, mainly because the sand filter media has a low sorptive capacity for heavy metals and their oxyanions. However, if the surfaces of sand particles are coated with iron or aluminum hydroxides, the adsorption capacity of the filter media is significantly enhanced (Meng, X. G. 1993. Effect of Component Oxide Interaction on the Adsorption Properties of Mixed Oxides, Ph.D. Thesis, Department of Civil and Environmental Engineering, Syracuse University, Syracuse, N.Y.).

In column adsorption studies, cationic metals (e.g., Cu, Cd, Zn and Pb) have been removed effectively by sand and granular activated carbon coated with ferric oxide (Benjamin, M. 1992. Metal Treatment at Superfund Sites by Adsorptive Filtration, EPA/540/F-92/008; Jarog, D. et al. 1992. Adsorption and Filtration with Oxide-Coated Granular Activated Carbon, ACS Meeting, San Francisco, Calif., pp. 711-714; Edwards, M. and M. Benjamin. 1989. J. Water Pollut. Control Fed. 61: 1523-1533). However, during these processes, the sand and activated carbon particles must be re-coated periodically and replaced in the filter. Further, the adsorptive capacity of the ferric oxide coating is much lower than that of fresh ferric hydroxide precipitate.

Microfiltration (Martin, J. F. et al. 1991. J. Air Waste Manage. Assoc. 41: 1653-1657) and adsorption and magnetic filtration (Chen, W. Y. et al. 1991. Res. J. Water Pollut. Control Fed. 63:958-964) have also been studied as means of removing heavy metals from water. The microfiltration process includes precipitation and filtration in two steps. The main difference between this process and the conventional precipitation and filtration treatment is that the heavy metal precipitates are removed directly by a membrane filter, without the coagulation and sedimentation steps. In the adsorption and magnetic filtration process, heavy metals are adsorbed onto fine magnetic particles coated with ferrihydrite. The magnetic particles are then collected using a magnetic filter. Finally, the magnetic particles are regenerated by metal desorption and reused.

Dermatas and Meng (1996. Removal of Arsenic Down to Trace Levels by Adsorptive Filtration, 2^{nd} Specialized Conference on Pretreatment of Industrial Wastewaters, Athens, Greece, pp. 191-198) tested an adsorptive filtration process for selective removal of arsenic from water. The process involved injection of ferric solution into the top layer, or deeper layers, of the sand bed. The stipulated mechanism responsible for removal of arsenic in this process is the coating of sand surfaces with ferric precipitate and subsequent adsorption of arsenic. A direct filtration process has been used for the treatment of source water [G. P. Treweek, J. AWWA, February, 96-100 (1979); M. R. Collins, et al, J. Environ. Eng., 113 (2), 330-344. (1987); J. R. Bratby, J. AWWA, December, 71-81 (1988)]. This direct filtration process included addition of coagulants to the water followed by flocculation and filtration. A flocculation time or hydraulic detention time of longer than 10 minutes was needed which required the installation of a large flocculation reactor prior to the sand filter.

U.S. patent application Ser. No. 10/049,107, of which the present application is a continuation-in-part, discloses a water treatment device comprising a bed of metallic iron particles (“zero-valent iron”) upstream of a sand filter. The majority of the dissolved contaminants in the influent stream are destroyed by chemical reactions at the surface of the iron particles. The residual contaminants in the effluent from the iron bed are co-precipitated by ferric oxides, generated by corrosion of the iron and captured by the sand filter.

### SUMMARY OF THE INVENTION

The present invention comprises an apparatus and method for removing dissolved contaminants from a dilute aqueous stream by a direct co-precipitation/filtration process. The apparatus includes a packed bed filter; an influent pipe for conveying a dilute aqueous stream to said packed bed filter; and an injection port for injection of a chemical solution into said influent line. The packed bed filter, influent pipe and injection port are arranged so that no substantial amount of particulate matter settles from the dilute aqueous stream between the injection port and the packed bed filter. This arrangement makes it unnecessary to provide a detention vessel for flocculation or sedimentation before the packed bed filter.

In the method, a hydrolysable metallic compound is added to the dilute aqueous stream, and the hydrolyzed metal co-precipitates with the contaminants. The resulting co-precipitate is filtered from the stream, preferably using a packed bed filter. Filtration and co-precipitation are performed concurrently in such a way that no substantial amount of particulate matter settles from the dilute aqueous stream before the start of said filtering step. Preferably, the dilute aqueous stream is filtered through a packed bed filter. It is also preferred that the addition of the hydrolysable metallic compound be performed less than seven minutes before the completion of the filtering step. Ferric salts are preferred as the hydrolysable metallic compound in the method of the invention, however, other metallic salts, such as aluminum sulfate, aluminum chloride, titanium sulfate, and titanium chloride. The method of the invention may be used effectively to remove dissolved contaminants that can be removed by conventional precipitation processes.

### BRIEF DESCRIPTION OF THE DRAWINGS

For a more complete understanding of the present invention, reference is made to the following detailed description of the present invention considered in conjunction with the accompanying drawings, in which:

FIG. 1 is a schematic diagram of a direct co-precipitation/filtration (DCF) process implemented according to the present invention.

FIG. 2 is a graph showing the effect of sand bed depth on arsenic removal in a DCF process implemented according to the present invention.

FIG. 3 is a graph showing the effect of iron dosages on effluent arsenic concentration in a DCF process implemented according to the present invention.

FIG. 4 is a graph showing the effect of influent arsenic concentrations on effluent arsenic concentrations in a DCF process implemented according to the present invention.

FIG. 5 is a graph showing the effect of hypochlorite addition on arsenite removal in a DCF process implemented according to the present invention.

FIG. 6 is a graph comparing the efficiency of arsenic removal by batch co-precipitation and by a DCF process implemented according to the present invention.

FIG. 7 is graph comparing influent arsenic concentrations to effluent arsenic concentrations with respect to a DCF process implemented according to the present invention.

FIG. 8 is graph of effluent fluoride concentrations against operating time for a DCF process implemented according to the present invention.

### DETAILED DESCRIPTION OF THE INVENTION

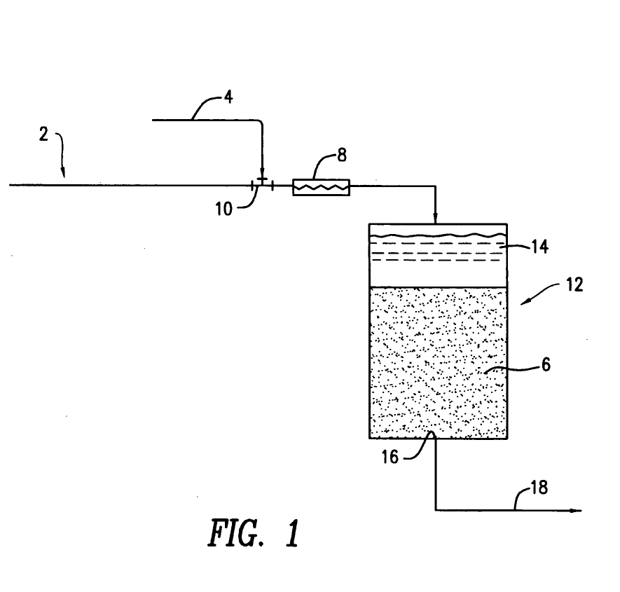

Referring to FIG. 1, dissolved inorganic contaminants can be removed from an aqueous stream 2 by direct co-precipitation/direct filtration. The direct co-precipitation/filtration (“DCF”) process comprises the injection of a co-precipitant 4 into the aqueous stream 2, followed by filtration of the aqueous stream 2 through a packed bed filter 6 without an intervening co-precipitation or settling vessel. The co-precipitant 4 comprises a hydrolysable metal compound in solution or slurry form injected into the aqueous stream 2 at an injection point 6. Suitable metal compounds include ferric chloride, ferric sulphate, aluminum sulphate, and other compounds known to be useful as precipitants or flocculants in water treatment. As shown in Example 9 of the co-pending, co-owned U.S. patent application Ser. No. 10/304,550 having a filing date of Nov. 26, 2002, the disclosure of which application is incorporated herein by reference, titanyl sulfate is a particularly effective co-precipitant for the removal of arsenic. Referring again to FIG. 1, an inline mixer 8 may be provided to mix the co-precipitant 4 into the aqueous stream 2, or mixing may occur through turbulent flow downstream of the injection point 10. The filtration vessel 12 contains a packed bed 6 of a particulate material, e.g., a silicate sand. The vessel 12 may also provide space for a reservoir 14 of water above the packed bed 6 to provide a pressure head for gravity filtration, or the filtration may be driven by pressurizing the influent stream 2 and the vessel 12 The injection point 10 is positioned upstream of the vessel 12 so that the total detention time of the aqueous stream 2 downstream of the injection point 10 is slightly longer than the time required for the injected metal compound to hydrolyze completely and co-precipitate with the dissolved inorganic contaminants. The detention time is the time required for a fixed volume of the aqueous stream to flow from the injection point 10 to the point 16 where the aqueous stream exits the packed bed 6. Preferably, the detention time for the hydrolysable metal compound is less than 10 minutes, or, more preferably, less than 7 minutes. Because of the short detention time, a substantial portion of the co-precipitant hydrolyzes within the packed bed 6, rather than in the reservoir 14, so that the co-precipitation and flocculation processes continue within the packed bed 6, distributing the metal hydroxides therein. Monitoring of the system performance and maintenance of the filter 12 are performed by conventional methods known in the art. The metal hydroxides within the packed bed continue to adsorb dissolved contaminants from the aqueous stream 2, further decreasing the concentrations of such contaminants in the effluent stream 18.

The removal of dissolved contaminants can be improved further by adding chemical oxidants or coagulation aids to the influent stream 2 upstream of the filter 10. For example, an oxidant such as a chlorite or permanganate can be added to convert dissolved metals to their higher oxidation states, enabling more ready precipitation from the dilute aqueous stream. The removal process, with or without the oxidative pretreatment, produces effluent contaminant concentrations on the order of micrograms per liter (μg/L) when the influent contaminant concentrations are on the order of a milligram per liter (mg/L) or less.

The following examples are intended to aid in the understanding of the methods and products of the present invention and are not intended to limit the scope or spirit of the invention in any way.

### EXAMPLE 1

### Arsenic Removal by Direct Co-Precipitation Filtration with Iron

Bench-scale column filtration tests were performed to evaluate the effectiveness of the direct coprecipitation filtration process in removing dissolved arsenic (As(V)) from water when dissolved iron (Fe(III)) was used as a co-precipitant. The configuration of the bench-scale DCF system used for these tests was similar to that shown in FIG. 1, with a water pump for the influent 2 and an injection pump for the co-precipitant solution 4. An in-line mixer 8 was not included in the bench-scale DCF system. The sand filter column 12 had an inside diameter of 3.0 inches (7.6 cm) and was packed with approximately 20 inches (51 cm) of quartz sand having an effective diameter of 0.35-0.60 mm and a uniformity coefficient of 1.2-1.6 (Ricci Bros. Sand Co. Inc., Port Norris, N.J.) to form the filter bed 6.

The sand filter was operated at a constant filtration rate of 3 gal/min▬ft², providing a detention time of about 2.5 minutes in the filter bed. The influent 2 was prepared by spiking tap water to a selected concentration of As(V) from a stock solution of As₂O₃. A co-precipitant solution 4, consisting of an acidified FeCl₃ solution containing 3-9 mM Fe(III), was directly injected into the influent stream before the sand filter. The equilibrium pH of the influent stream, after addition of the acidified FeCl₃ solution, was about 6.7.

During the filtration tests, water samples were collected via sampling ports located at approximate filter bed depths of 1.3, 5, 10 and 15 inches below the top of the filter bed 6 and in the effluent line 18 (i.e., at an approximate filter bed depth of 20 inches). The samples were taken after 85 bed volumes of influent had passed through the filter. Total and dissolved arsenic concentrations were determined by analyzing the water samples before and after filtration through polycarbonate membranes of 0.4 μm pore size. Iron and arsenic concentrations were measured by graphite furnace atomic adsorption spectroscopy (Varian SpectrAA-400, Varian, Inc., Palo Alto, Calif.) to the method detection limit of 0.7 μg/L.

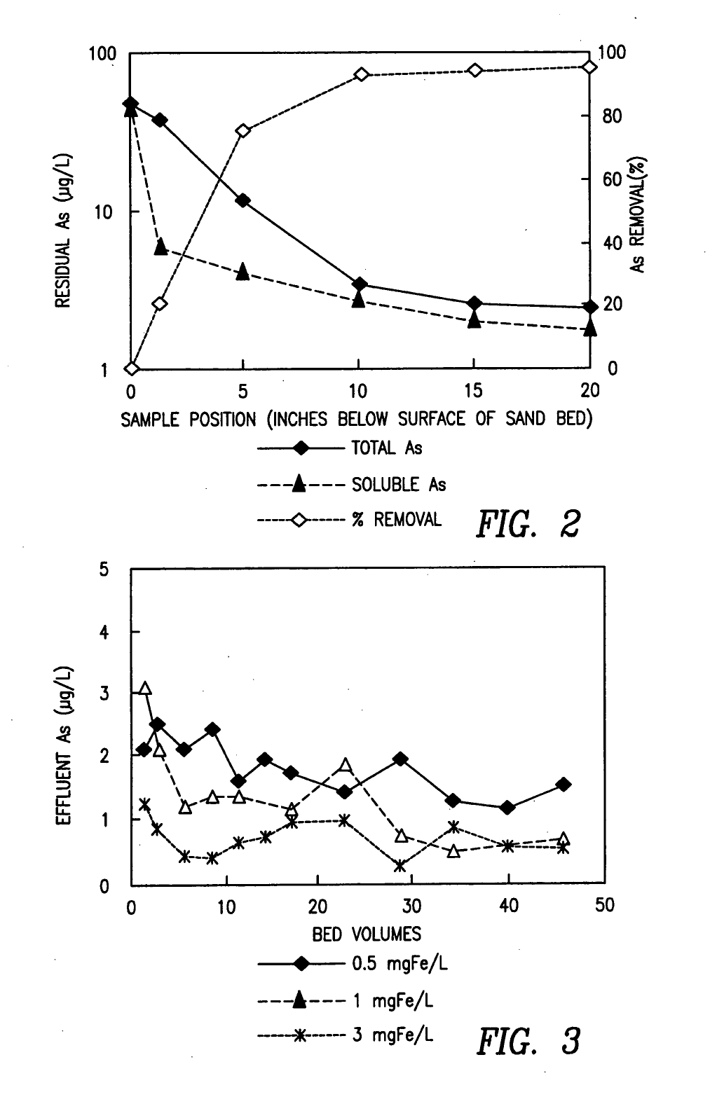

Table 1 shows the measured concentrations and percent removal of total and dissolved (<0.4 μm) iron and total and dissolved arsenic in the sand filter at the depths sampled, as well as the fraction of the total iron or arsenic that is filterable (i.e., the percent of the total analyte that is associated with particles that are not passed by the 0.4 μm filter). These data are also presented graphically in FIG. 2. The DCF process removed about 95% of the arsenic present in the influent stream and about 97% of the iron added as a co-precipitant. Over 90% of the iron and arsenic were removed in the top 10 inches of the filter bed. The continuous decrease in the concentrations of dissolved iron and dissolved arsenic throughout the filter bed indicate recipitation, aggregation, and removal of the particles occurred simultaneously in and bed.

TABLE 1
Removal of Iron and Arsenic in Filter Bed

| Depth | | | | | | | | |
|---|---|---|---|---|---|---|---|---|
| of filter | Fe, | | Fe, | | | | As, | |
| bed | total | Removal | dissolved | % Fe, | As, total | Removal | dissolved | % As, |
| (inches) | (μg/L) | (%). | (μg/L) | filterable | (μg/L) | (%) | (μg/L) | filterable |
| 0 | 1,000 | — | 1,000 | 100 | 50.0 | — | 50.0 | 100 |
| 1.3 | 918 | 8.2 | 166 | 82 | 37.5 | 25 | 5.9 | 84 |
| 5 | 493 | 51 | 120 | 76 | 11.6 | 77 | 4.1 | 64 |
| 10 | 62 | 94 | 49 | 21 | 3.5 | 93 | 2.7 | 23 |
| 15 | 38 | 96 | 28 | 26 | 2.6 | 95 | 2.0 | 23 |
| 20 | 26 | 97 | 21 | 19 | 2.4 | 95 | 1.8 | 25 |

To determine the effects of flocculation on arsenic removal, a number of filtration tests were conducted wherein the ferric chloride solution was pre-mixed with water in an in-line container, providing a hydraulic detention time of 7 minutes, to allow the precipitate to form a floc prior to filtration. The results in Table 2 below show that providing seven (7) minutes of flocculation before filtration improved the removal of iron. However, the 7-minute flocculation period resulted in lower removals of arsenic than were achieved by the DCF system. The flocculation step was not performed in tests of the DCF process described in Examples 2-6, below.

TABLE 2
Effects of Flocculation on Iron and Arsenic Removal in Filter Bed

| Removal after 7 minutes of flocculation | | | | | | | | |
|---|---|---|---|---|---|---|---|---|
| Depth | | | | | Removal without flocculation | | | |
| of filter | Fe, | Fe, | As, | As, | | Fe, | | As, |
| bed | total | dissolved | total | dissolved | Fe, total | dissolved | As, total | dissolved |
| (inches) | (μg/L) | (μg/L) | (μg/L) | (μg/L) | (μg/L) | (μg/L) | (μg/L) | (μg/L) |
| 0 | 1,000 | — | 50.0 | — | 1,000 | — | 50.0 | — |
| 1.3 | 797 | 139 | 27 | 7.3 | 918 | 166 | 37.5 | 5.9 |
| 5 | 172 | 73 | 8.8 | 5 | 493 | 120 | 11.6 | 4.1 |
| 10 | 58 | 38 | 4.8 | 3.8 | 62 | 49 | 3.5 | 2.7 |
| 15 | 29 | 23 | 4.4 | 3.6 | 38 | 28 | 2.6 | 2.0 |
| 20 | 16 | 15 | 4.4 | 3 | 26 | 21 | 2.4 | 1.8 |

### EXAMPLE 2

### Effect of Iron Dosage on Effluent Arsenic Concentration

Bench-scale column filtration tests were performed to examine the effect of iron (Fe(III)) dosage on arsenic removal using the DCF test apparatus of Example 1. The tests were performed on an influent consisting of tap water spiked to a concentration of 16 μg As(V)/L. In each test, the influent was dosed to a selected concentration of iron upstream of the sand filter. Tests were run at dosages of 0.5, 1.0 and 3.0 mg Fe(III)/L. Samples were collected from the effluent stream 18 throughout each test and analyzed for arsenic. Referring to FIG. 3, an iron dosage of 0.5 mg Fe(III)/L resulted in an effluent arsenic concentration of approximately 1.8 μg As(V)/L. At an iron dosage of 1 mg Fe(III)/L, the effluent arsenic concentration was reduced to about 1 μg As(V)/L. Increasing the iron dosage to 3 mg Fe(III)/L did not result in a commensurate decrease in effluent arsenic concentration below 1 μg As(V)/L.

### EXAMPLE 3

### Effect of Influent Arsenic Concentration on Arsenic Removal

Bench-scale column filtration tests were performed to evaluate the effect of the influent arsenic (As(V)) concentration on removal of arsenic by the DCF test apparatus of Example 1. Tests were performed on tap water samples spiked to arsenic concentrations of 16, 50, 90 and 180 μg As(V)/L, respectively. A separate test was performed using contaminated groundwater having an arsenic concentration of 70 μg As(V)/L. The influent streams were dosed to an iron concentration of 1 mg Fe(III)/L in each test.

Referring to FIG. 4, the DCF process reduced the effluent arsenic concentrations to about 1 μg As(V)/L in the 16 and 50 μg As(V)/L samples after less than 10 bed volumes of influent were passed through the sand filter. The effluent arsenic concentration increased to about 3 μg As(V)/L when the influent arsenic concentration was increased to 90 μg As(V)/L. A larger volume of influent, about 20 bed volumes, was treated before the effluent arsenic concentration reached a pseudo-steady state. The arsenic concentration in the groundwater sample was reduced from an influent concentration of 70 μg As(V)/L to an effluent concentration of less than 3 μg As(V)/L after about 9 bed volumes of groundwater had been treated. At an influent arsenic concentration of 180 μg As(V)/L, the effluent arsenic concentration was initially very high, but reached a pseudo-steady state concentration of approximately 8 μg As(V)/L after about 20 bed volumes of influent had been treated.

### EXAMPLE 4

### Effect of Oxidant Addition on Arsenite Removal

Bench-scale column filtration tests were performed using the DCF test apparatus of Example 1 to evaluate the effectiveness of the DCF process in removing arsenite (As(III)) from spiked tap water samples. Arsenite, from a stock solution of NaAsO₂, was added to the tap water to a concentration of 90 μg As(III)/L. To mitigate the oxidation of arsenite by residual chlorine in the tap water, 2.5 mg/L of Na₂SO₃ was added to the tap water to react with the free chlorine for 1 hour prior to the addition of the arsenite stock solution. Speciation analysis indicated that 81-87% of the arsenite added to the tap water samples remained in arsenite form. A coprecipitant solution 4 of acidified FeCl₃ was added to the influent 2 to a concentration of 1 mg Fe(III)/L. Samples were collected from the effluent stream 18 and analyzed for arsenic (As), i.e., the combined concentrations of all species of arsenic. In selected bench filtration tests, NaOCl was added to the influent to an initial concentration 0.5 mg Cl₂/L upstream of the sand filter, as an oxidant to transform the arsenite (As(III)) to arsenite (As(V)).

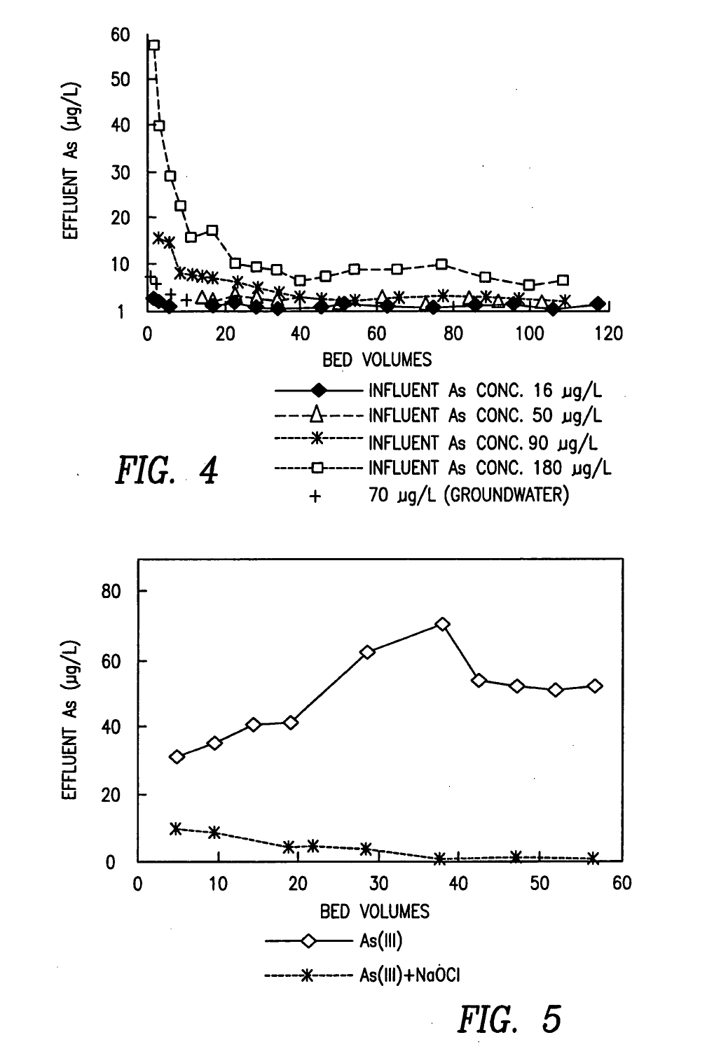

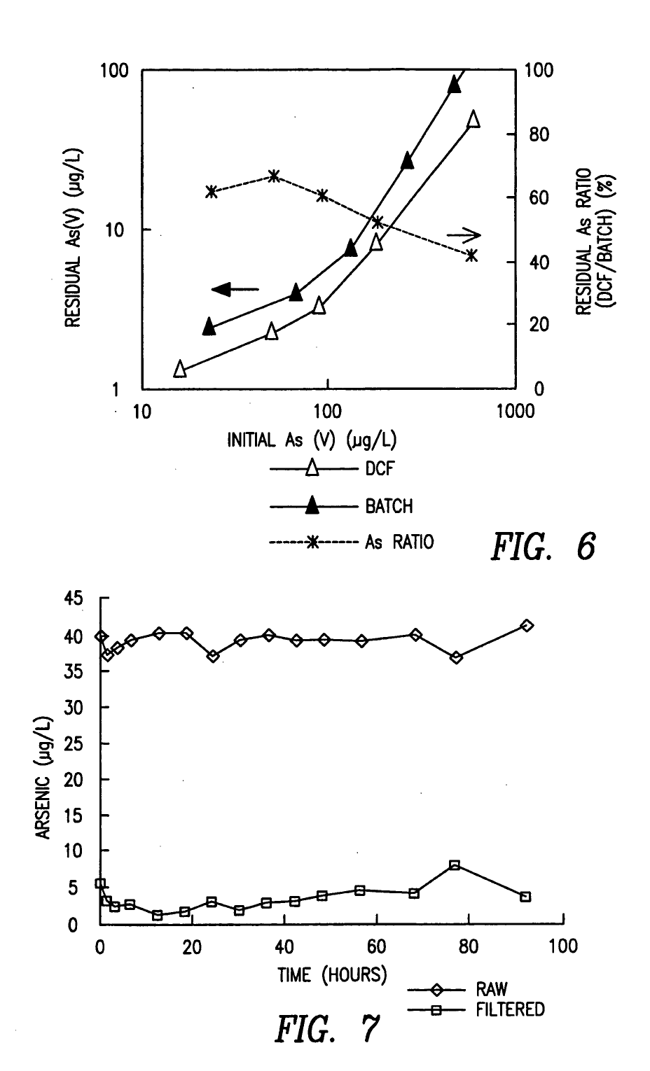

Referring to FIG. 5, the arsenic concentration in the effluent from the DCF test apparatus varied from 31-70 μg As/L. When NaOCl solution was added to the influent concurrently with the co-precipitant solution 4, the effluent arsenic concentration was reduced to less than 5 μg As/L after 20 bed volumes of influent were filtered. In this case, both the oxidation of arsenite and the coprecipitation of arsenite occurred within the filter bed.

### EXAMPLE 5

### Comparison of Arsenic Removal Efficiency by DCF and Batch Coprecipitation

Bench-scale column filtration tests and batch coprecipitation tests were performed to compare the effectiveness of the DCF process in removing arsenic from tap water to that of batch coprecipitation.

The bench-scale column filtration tests were performed using the DCF test apparatus and test protocol of Example 3. Effluent samples were analyzed for arsenic throughout each DCF test and averaged to obtain the residual arsenic concentrations reported in FIG. 6.

Batch co-precipitation experiments were conducted using a jar test mixer (Phipps & Bird, Inc., Richmond, Va.) and 1-L glass beakers. An acidified FeCl₃ solution (36 mM Fe(III)) was added to samples of the arsenic-spiked tap water in the beakers during mixing. The suspension was mixed rapidly at a rotating speed of 120 rpm for 1 minute. After rapid mixing, the suspension was mixed at a rotating speed of 40 rpm. Samples were taken after 30 minutes of co-precipitation and flocculation selected and filtered through 0.4 μm pore size membranes to separate the solution from the solids for analysis of arsenic and iron.

Tap water was spiked with a stock solution of As₂O₅ to a selected concentration of arsenic (As(V)) for each bench-scale column filtration test and batch coprecipitation test. The influent samples were spiked to an iron concentration of 1 mg Fe(III)/L and adjusted to a pH of about 6.7.

Referring to FIG. 6, the DCF process removed dissolved arsenic to lower concentrations than the batch co-precipitation process. At an initial arsenic concentration of 50 μg As/L, the residual arsenic concentration in the water treated by the DCF process was 2.2 μg As/L and the residual concentration in the water treated by batch co-precipitation was 3.3 μg As/L. Therefore, the ratio of the residual arsenic concentration from the DCF process to the residual arsenic concentration from the batch coprecipitation process was 66.7%. When the initial arsenic concentration was increased to 600 μg As/L, the ratio decreased to 42%, demonstrating an increased rate of arsenic removal for the DCF process over the rate of arsenic removal for the batch coprecipitation process at the higher influent arsenic concentration.

### EXAMPLE 6

### Removal of Arsenic from Groundwater in a Field Pilot Test

A 92-hour pilot test was performed using a DCF system installed at a wellhead to evaluate the effectiveness of the DCF process in removing arsenic from contaminated well water. The influent well water was pumped through a dual-media filter having an inside diameter of 14 inches, and a 24-inch deep sand filter bed over a 12-inch deep anthracite bed. Ferric chloride solution was injected in-line into the influent upstream of the dual-media filter. The filtration rate was controlled between 3 and 6 gallons-per-minute per square foot (GPM/ft²). The iron concentration in the influent varied between zero and 1.5 mg Fe(III)/L. During the filtration test, samples of influent well water and filtered effluent were collected and analyzed for total arsenic and other parameters. Total arsenic concentrations measured in the raw influent and the filtered effluent.

The arsenic content in the influent well water samples ranged from 36.6 to 41.0 μg As/L. Speciation analysis showed that less than 10% of the total arsenic was in the arsenite (As(III)) form, and the remainder of the arsenic was in the arsenate (As(V)) form, which is easier to remove by adsorption than arsenite. Because the concentration of arsenite in the groundwater was very low (<3 μg As(III)/L), no oxidants were added to the influent during the filtration test.

The DCF process reduced the arsenic concentration in the effluent to a range of 1.2-4.6 μg As/L over the most of the duration of the test (approximately 3 days). The effluent concentration increased to 7.9 μg As/L after 77 hours of continuous operation.

TABLE 3
Arsenic concentrations measured during the pilot DCF test.

| Time | Influent | Effluent |
|---|---|---|
| Elapsed after | Arsenic | Arsenic |
| Start of Test (h) | (μg As/L) | (μg As/L) |
| 0 | 39.6 | 5.6 |
| 1 | 37.3 | 3.1 |
| 3 | 38.1 | 2.4 |
| 6 | 39.1 | 2.7 |
| 12 | 40.1 | 1.2 |
| 18 | 40.1 | 1.6 |
| 24 | 36.9 | 3.0 |
| 30 | 39.1 | 1.9 |
| 36 | 39.8 | 2.8 |
| 42 | 39.1 | 3.1 |
| 48 | 39.0 | 3.7 |
| 56 | 38.9 | 4.6 |
| 68 | 39.8 | 4.0 |
| 77 | 36.6 | 7.9 |
| 92 | 41.0 | 3.5 |

### EXAMPLE 7

### Removal of Fluoride from Groundwater in a Field Pilot Test

A pilot test was performed using a DCF system installed at a wellhead to evaluate the effectiveness of the DCF process in removing fluoride from contaminated well water. Groundwater was pumped through dual-media filters at a flow rate of 3 GPM/ft². The filter columns had an inside diameter of 4 inches and were packed with approximately 3 feet of sand over 3 feet of anthracite. Alum (aluminum sulfate) at concentrations of 20-24 mg/L and organic coagulants were injected into the influent upstream of the filters.

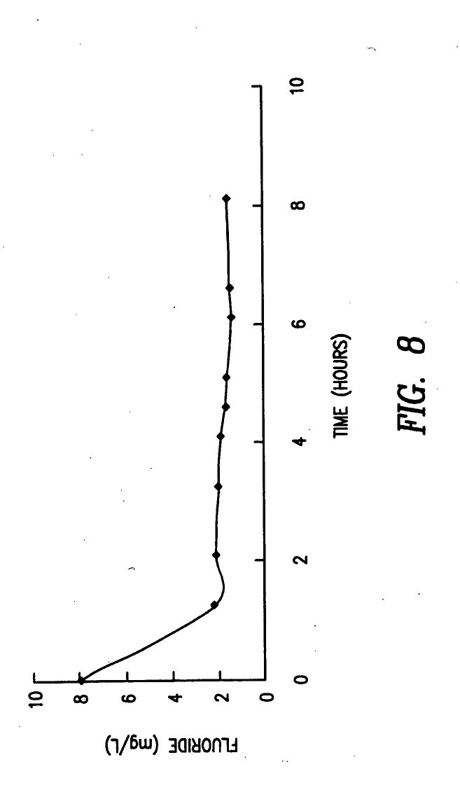

The influent well water had a fluoride concentration of 7.9 mg/L, a pH of 8.1, and an arsenic concentration of about 13.5 μg/L. Effluent fluoride concentrations, plotted against the operating time of the DCF system, are shown in FIG. 8. The first point plotted on FIG. 8 (i.e., at time=0 hours) is the influent fluoride concentration. The fluoride concentration was reduced from 8 mg/L to less than about 2 mg/L during 8 hours of operation. Arsenic concentrations were reduced from 13.5 μg/L to less than 1 μg/L.

As demonstrated by the Examples provided above, the direct co-precipitation/filtration process of the present invention provides a high degree of removal for dissolved arsenic. In particular, the process consistently removed from over 90% to 97% of the dissolved arsenic from dilute aqueous solutions and achieved a higher degree of removal than a conventional batch precipitation/filtration process. Approximately 75% removal was also achieved for dissolved fluoride which has been shown to be a particularly difficult substance to remove from water by conventional treatment processes. The high removals disclosed in the Examples were achieved by introducing a metal salt as a co-precipitant immediately upstream of a column filter without an intervening flocculation or sedimentation unit. Such a process can be implemented in a treatment system that has a significantly smaller footprint, and at a smaller capital cost, than conventional co-precipitation/filtration processes.

It should be understood that the embodiments described herein are merely exemplary and that a person skilled in the art may make many variations and modifications thereto without departing from the spirit and scope of the present invention. All such variations and modifications, including those discussed above, are intended to be included within the scope of the invention as defined in the appended claims. As discussed above, metal salts other than ferric salts, such as the sulfates or chlorides of aluminum or titanium, may be used in the direct co-precipitation filtration process. Moreover, the process may be used to remove any dissolved contaminant, whether inorganic or organic, that can be removed from dilute aqueous solutions by conventional co-precipitation/filtration processes. Such dissolved contaminants include, but are not limited to, aluminum, antimony, arsenic(III), arsenic(V), barium, cadmium, cesium, chromium, cobalt, copper, gallium, gold, iron, lead, manganese, mercury, molybdenum, nickel, platinum, radium, selenium, silver, strontium, tellerium, tin, tungsten, uranium, vanadium, zinc, fluoride, nitrite, phosphate, sulfite, sulfide, and a low-molecular weight organic arsenic compound

1. A water filtration device for removing dissolved metals from a dilute aqueous stream, comprising
a packed bed filter;
an influent pipe for conveying a dilute aqueous stream to said packed bed filter; and
an injection port for injection of a chemical solution into said influent line;
wherein said packed bed filter, said influent pipe and said injection port are arranged so that no substantial amount of particulate matter will settle from said dilute aqueous stream between said injection port and said packed bed filter.

2. The device of claim 1, wherein said packed bed filter comprises a bed of sand.

3. The device of claim 1, wherein said packed bed filter is a dual-media filter.

4. A method for removing dissolved contaminants from a dilute aqueous stream, comprising the steps of
adding a hydrolysable compound of a metal to said dilute aqueous stream;
co-precipitating a hydrolyzed compound of said metal and said contaminants from said dilute aqueous stream, thereby forming a co-precipitate; and
filtering said co-precipitate from the dilute aqueous stream,
wherein said filtering step is performed concurrently with said co-precipitating steps, and wherein said method is performed so that no substantial amount of particulate matter settles from the dilute aqueous stream before the start of said filtering step.

5. The method of claim 4, wherein said filtering step is performed using a packed bed filter.

6. The method of claim 5, wherein said adding step is performed less than seven minutes before the completion of said filtering step.

7. The method of claim 6, wherein said adding step includes injecting a solution of ferric iron into the dilute aqueous stream.

8. The method of claim 7, wherein the dilute aqueous stream contains arsenite, said method further comprising the step of adding to said dilute aqueous stream a chemical oxidant for oxidizing arsenite to arsenate before the start of said filtering step.

9. The method of claim 1, wherein said hydrolysable compound of a metal comprises a compound selected from the group consisting of ferric chloride, ferric sulfate, ferrous sulfate, aluminum sulfate, aluminum chloride, titanium sulfate, and titanium chloride.

10. The method of claim 1, wherein the dilute aqueous stream contains a dissolved substance selected from the group consisting of aluminum, antimony, arsenic(III), arsenic(V), barium, cadmium, cesium, chromium, cobalt, copper, gallium, gold, iron, lead, manganese, mercury, molybdenum, nickel, platinum, radium, selenium, silver, strontium, tellerium, tin, tungsten, uranium, vanadium, zinc, fluoride, nitrite, phosphate, sulfite, sulfide, and a low-molecular weight organic arsenic compound.
